(19) United States
(12) Patent Application Publication
(10) Pub. No.: US 2015/0029327 A1
(43) Pub. Date: Jan. 29, 2015

(54) IMAGING APPARATUS, DISPLAY DATA GENERATING APPARATUS, IMAGING SYSTEM, AND METHOD FOR CONTROLLING THE SAME

(71) Applicant: CANON KABUSHIKI KAISHA, Tokyo (JP)

(72) Inventor: Naoto Abe, Machida-shi (JP)

(21) Appl. No.: 14/354,026

(22) PCT Filed: Dec. 6, 2012
(86) PCT No.: PCT/JP2012/007814

§ 371 Date: Apr. 24, 2014

(30) Foreign Application Priority Data
Dec. 22, 2011 (JP) 2011-281835
Jul. 31, 2012 (JP) 2012-170174

(51) Int. Cl. G02B 21/36

(52) U.S. Cl. CPC G02B 21/361
USPC 348/80

(57) ABSTRACT

Image data of a specimen is acquired by applying an image processing to imaging data obtained by imaging for the specimen by means of an imaging device while controlling an exposure amount. First image data is generated by using the exposure amount and a parameter of the image processing to be determined while permitting provision of different values for each of distinct pieces of the first image data on condition that pixel values of pixels corresponding to portions of the specimen having an identical transmittance have an identical value in relation to all pieces of the first image data to be generated. Second image data is generated by using the exposure amount and a parameter of the image processing to be adaptively determined on the basis of a feature of the specimen. Display screen data, which includes at least the first image data, is generated.

### TECHNICAL FIELD

The present invention relates to an imaging apparatus, a display data generating apparatus, an imaging system, and a method for controlling the same.

### BACKGROUND ART

A technique is disclosed, which relates to such a system that an image is captured by using a digital microscope called “virtual microscope” and the image is observed by using an application software called “viewer” (see Patent Literature 1 and Patent Literature 2).

In Patent Literature 1, a calculating unit is provided, which calculates the full size (actual size) magnification of medical image data with respect to a display unit on the basis of a pixel pitch of the medical image data and a pixel pitch of the display unit. Further, a display processing unit is provided, which allows a full-scale image of the medical image data to be displayed on the display unit in accordance with a calculation result of the calculating unit. Accordingly, the full-scale medical image can be displayed.

On the other hand, Patent Literature 2 discloses that the brightness can be adjusted for a microscope photographing apparatus by controlling the exposure time and the light amount radiated onto a photographic subject.

### CITATION LIST

### Patent Literature

PTL 1: Japanese Patent Application Laid-open No. 2002-251464
PTL 2: Japanese Patent Application Laid-open No. 2005-221708

### SUMMARY OF INVENTION

### Technical Problem

In a digital microscope system (virtual microscope) in which the image data (virtual slide) obtained by performing the imaging by means of an imaging apparatus is observed by means of a viewer, the following processings are performed in order that an observer can perform the observation with ease. That is, the exposure amount (the exposure time for an imaging device and the incoming light amount allowed to come into the imaging device as determined, for example, by the brightness of an illumination and the diaphragm (stop) of an optical system) is adjusted adaptively on the basis of the transmittance of a specimen, the image processing (the adjustment of, for example, the brightness, the color temperature, and the gradation characteristic) is performed in order to provide a high image quality, and thus the image data is generated. In the case of the digital microscope as described above, for example, even when the staining of the specimen is thin, it is possible to obtain the image data with which the observation can be performed with ease wherein the contrast is raised by means of the image processing from the imaging data obtained by performing the imaging while selecting the optimum exposure amount. Patent Literature 2 discloses a technique in relation to an image processing in which the brightness is adjusted. Further, the procedure, in which an image is captured while selecting the optimum exposure amount upon the imaging, resides in a method which is usually performed such that the exposure is determined by means of, for example, AE of a camera when the image is captured while attaching the camera to a microscope.

However, the following problem arises when the image diagnosis is performed on the basis of the image data for which the image processing has been performed as described above. That is, an observer cannot decide, in some cases, whether the portion, which seems to be any abnormality (lesion) in the presented image data, is something brought about by photographing an abnormality existing in an original specimen or any artifact brought about by the image processing. Therefore, there is such a possibility that the diagnosis may result in any erroneous diagnosis.

An object of the present invention is to provide such a technique that a user can easily judge whether any abnormality, which is found in an image, is something brought about by an abnormality existing in a specimen or any artifact resulting from an image processing, when the user observes image data obtained by performing the imaging by means of an imaging apparatus.

### Solution to Problem

The present invention resides in a method for controlling an imaging apparatus for acquiring image data of a specimen by applying an image processing to imaging data obtained by imaging for the specimen by means of an imaging device while controlling an exposure amount determined by an exposure time and an incoming light amount per unit time allowed to come into the imaging device, the method for controlling the imaging apparatus comprising:

a step of generating first image data;

a step of generating second image data; and

a step of generating data including the first image data and the second image data as the image data of the specimen, wherein:

the first image data is generated in the step of generating the first image data by the imaging and the image processing by using the exposure amount and a parameter of the image processing to be determined while permitting provision of different values for each of distinct pieces of the first image data on condition that pixel values of pixels corresponding to portions of the specimen having an identical transmittance have an identical value in relation to all pieces of the first image data to be generated; and

the second image data is generated in the step of generating the second image data by the imaging and the image processing by using the exposure amount and a parameter of the image processing to be adaptively determined on the basis of a feature of the specimen for each of distinct pieces of the second image data to be generated.

The present invention resides in a method for controlling an imaging apparatus for acquiring image data of a specimen by applying an image processing to imaging data obtained by imaging for the specimen by means of an imaging device while controlling an exposure amount determined by an exposure time and an incoming light amount per unit time allowed to come into the imaging device, the method for controlling the imaging apparatus comprising:

a step of generating second image data;

a step of generating third image data; and

a step of generating data including the second image data and the third image data as the image data of the specimen, wherein:

the second image data is generated in the step of generating the second image data by the imaging and the image processing by using the exposure amount and a parameter of the image processing to be adaptively determined on the basis of a feature of the specimen for each of distinct pieces of the second image data to be generated; and

the third image data is generated from the second image data in the step of generating the third image data by acquiring information of the exposure amount and the parameter of the image processing used to generate the second image data and performing an image processing which corresponds to inverse transformation of the imaging based on the exposure amount and an image processing which corresponds to inverse transformation of the image processing based on the use of the parameter of the image processing.

The present invention resides in a method for controlling a display data generating apparatus for generating display screen data for presenting, to a user by a display apparatus, an image based on image data of a specimen acquired by an imaging apparatus for acquiring the image data of the specimen by applying an image processing to imaging data obtained by imaging for the specimen by means of an imaging device while controlling an exposure amount determined by an exposure time and an incoming light amount per unit time allowed to come into the imaging device, the method for controlling the display data generating apparatus comprising:

a step of acquiring the image data of the specimen including first image data and second image data from the imaging apparatus or a storage device; and

a step of further generating, in addition to display screen data for presenting an image based on the second image data, at least any one of display screen data for presenting an image based on the first image data and display screen data for presenting both of the image based on the first image data and the image based on the second image data, wherein:

the first image data is image data which is generated by the imaging and the image processing by using the exposure amount and a parameter of the image processing to be determined while permitting provision of different values for each of distinct pieces of the first image data on condition that pixel values of pixels corresponding to portions of the specimen having an identical transmittance have an identical value in relation to all pieces of the first image data; and

the second image data is image data which is generated by the imaging and the image processing by using the exposure amount and a parameter of the image processing to be adaptively determined on the basis of a feature of the specimen every time when the second image data is generated.

The present invention resides in a method for controlling a display data generating apparatus for generating display screen data for presenting, to a user by a display apparatus, an image based on image data of a specimen acquired by an imaging apparatus for acquiring the image data of the specimen by applying an image processing to imaging data obtained by imaging for the specimen by means of an imaging device while controlling an exposure amount determined by an exposure time and an incoming light amount per unit time allowed to come into the imaging device, the method for controlling the display data generating apparatus comprising:

a step of acquiring second image data and information of the exposure amount and a parameter of the image processing used to generate the second image data from the imaging apparatus or a storage device;

a step of generating third image data from the second image data by performing, based on the use of the parameter of the image processing on the basis of the exposure amount and the parameter of the image processing, an image processing which corresponds to inverse transformation of the imaging based on the exposure amount and an image processing which corresponds to inverse transformation of the image processing with respect to the second image data; and

a step of further generating, in addition to display screen data for presenting an image based on the second image data, at least any one of display screen data for presenting an image based on the third image data and display screen data for presenting both of the image based on the third image data and the image based on the second image data.

The present invention resides in a method for controlling an imaging system, the imaging system comprising:

an imaging apparatus for acquiring image data of a specimen by applying an image processing to imaging data obtained by imaging for the specimen by means of an imaging device while controlling an exposure amount determined by an exposure time and an incoming light amount per unit time allowed to come into the imaging device; and

a display data generating apparatus for generating display screen data for presenting, to a user by a display apparatus, an image based on the image data of the specimen acquired by the imaging apparatus, the method for controlling the imaging system comprising, in relation to the imaging apparatus:

a step of generating first image data;

a step of generating second image data; and

a step of generating data including the first image data and the second image data as the image data of the specimen, wherein:

the first image data is generated in the step of generating the first image data by the imaging and the image processing by using the exposure amount and a parameter of the image processing to be determined while permitting provision of different values for each of distinct pieces of the first image data on condition that pixel values of pixels corresponding to portions of the specimen having an identical transmittance have an identical value in relation to all pieces of the first image data to be generated; and

the second image data is generated in the step of generating the second image data by the imaging and the image processing by using the exposure amount and a parameter of the image processing to be adaptively determined on the basis of a feature of the specimen for each of distinct pieces of the second image data to be generated, and the method for controlling the imaging system further comprising, in relation to the display data generating apparatus:

a step of acquiring the image data of the specimen including the first image data and the second image data from the imaging apparatus; and

a step of further generating, in addition to display screen data for presenting an image based on the second image data, at least any one of display screen data for presenting an image based on the first image data and display screen data for presenting both of the image based on the first image data and the image based on the second image data.

The present invention resides in a method for controlling an imaging system, the imaging system comprising:

an imaging apparatus for acquiring image data of a specimen by applying an image processing to imaging data obtained by imaging for the specimen by means of an imaging device while controlling an exposure amount determined by an exposure time and an incoming light amount per unit time allowed to come into the imaging device; and

a display data generating apparatus for generating display screen data for presenting, to a user by a display apparatus, an image based on the image data of the specimen acquired by the imaging apparatus, the method for controlling the imaging system comprising, in relation to the imaging apparatus:

a step of generating second image data;

a step of generating third image data; and

a step of generating data including the second image data and the third image data as the image data of the specimen, wherein:

the second image data is generated in the step of generating the second image data by the imaging and the image processing by using the exposure amount and a parameter of the image processing to be adaptively determined on the basis of a feature of the specimen for each of distinct pieces of the second image data to be generated; and

the third image data is generated from the second image data in the step of generating the third image data by acquiring information of the exposure amount and the parameter of the image processing used to generate the second image data and performing an image processing which corresponds to inverse transformation of the imaging based on the exposure amount and an image processing which corresponds to inverse transformation of the image processing based on the use of the parameter of the image processing, and the method for controlling the imaging system further comprising, in relation to the display data generating apparatus:

a step of acquiring the image data of the specimen including the second image data and the third image data from the imaging apparatus; and

a step of further generating, in addition to display screen data for presenting an image based on the second image data, at least any one of display screen data for presenting an image based on the third image data and display screen data for presenting both of the image based on the third image data and the image based on the second image data.

The present invention resides in an imaging apparatus for acquiring image data of a specimen by applying an image processing to imaging data obtained by imaging for the specimen by means of an imaging device while controlling an exposure amount determined by an exposure time and an incoming light amount per unit time allowed to come into the imaging device, the imaging apparatus comprising:

a unit configured to generate first image data;

a unit configured to generate second image data; and

a unit configured to generate data including the first image data and the second image data as the image data of the specimen, wherein:

the first image data is generated by the unit configured to generate the first image data by the imaging and the image processing by using the exposure amount and a parameter of the image processing to be determined while permitting provision of different values for each of distinct pieces of the first image data on condition that pixel values of pixels corresponding to portions of the specimen having an identical transmittance have an identical value in relation to all pieces of the first image data to be generated; and

the second image data is generated by the unit configured to generate the second image data by the imaging and the image processing by using the exposure amount and a parameter of the image processing to be adaptively determined on the basis of a feature of the specimen for each of distinct pieces of the second image data to be generated.

The present invention resides in an imaging apparatus for acquiring image data of a specimen by applying an image processing to imaging data obtained by imaging for the specimen by means of an imaging device while controlling an exposure amount determined by an exposure time and an incoming light amount per unit time allowed to come into the imaging device, the imaging apparatus comprising:

a unit configured to generate second image data;

a unit configured to generate third image data; and

a unit configured to generate data including the second image data and the third image data as the image data of the specimen, wherein:

the second image data is generated by the unit configured to generate the second image data by the imaging and the image processing by using the exposure amount and a parameter of the image processing to be adaptively determined on the basis of a feature of the specimen for each of distinct pieces of the second image data to be generated; and

the third image data is generated from the second image data by the unit configured to generate the third image data by acquiring information of the exposure amount and the parameter of the image processing used to generate the second image data and performing an image processing which corresponds to inverse transformation of the imaging based on the exposure amount and an image processing which corresponds to inverse transformation of the image processing based on the use of the parameter of the image processing.

The present invention resides in a display data generating apparatus for generating display screen data for presenting, to a user by a display apparatus, an image based on image data of a specimen acquired by an imaging apparatus for acquiring the image data of the specimen by applying an image processing to imaging data obtained by imaging for the specimen by means of an imaging device while controlling an exposure amount determined by an exposure time and an incoming light amount per unit time allowed to come into the imaging device, the display data generating apparatus comprising:

a unit configured to acquire the image data of the specimen including first image data and second image data from the imaging apparatus or a storage device; and

a unit configured to further generate, in addition to display screen data for presenting an image based on the second image data, at least any one of display screen data for presenting an image based on the first image data and display screen data for presenting both of the image based on the first image data and the image based on the second image data, wherein:

the first image data is image data which is generated by the imaging and the image processing by using the exposure amount and a parameter of the image processing to be determined while permitting provision of different values for each of distinct pieces of the first image data on condition that pixel values of pixels corresponding to portions of the specimen having an identical transmittance have an identical value in relation to all pieces of the first image data; and

the second image data is image data which is generated by the imaging and the image processing by using the exposure amount and a parameter of the image processing to be adaptively determined on the basis of a feature of the specimen every time when the second image data is generated.

The present invention resides in a display data generating apparatus for generating display screen data for presenting, to a user by a display apparatus, an image based on image data of a specimen acquired by an imaging apparatus for acquiring the image data of the specimen by applying an image processing to imaging data obtained by imaging for the specimen by means of an imaging device while controlling an exposure amount determined by an exposure time and an incoming light amount per unit time allowed to come into the imaging device, the display data generating apparatus comprising:

a unit configured to acquire second image data and information of the exposure amount and a parameter of the image processing used to generate the second image data from the imaging apparatus or a storage device;

a unit configured to generate third image data from the second image data by performing, based on the use of the parameter of the image processing on the basis of the exposure amount and the parameter of the image processing, an image processing which corresponds to inverse transformation of the imaging based on the exposure amount and an image processing which corresponds to inverse transformation of the image processing with respect to the second image data; and

a unit configured to further generate, in addition to display screen data for presenting an image based on the second image data, at least any one of display screen data for presenting an image based on the third image data and display screen data for presenting both of the image based on the third image data and the image based on the second image data.

The present invention resides in an imaging system comprising:

an imaging apparatus for acquiring image data of a specimen by applying an image processing to imaging data obtained by imaging for the specimen by means of an imaging device while controlling an exposure amount determined by an exposure time and an incoming light amount per unit time allowed to come into the imaging device; and

a display data generating apparatus for generating display screen data for presenting, to a user by a display apparatus, an image based on the image data of the specimen acquired by the imaging apparatus, the imaging apparatus comprising:

a unit configured to generate first image data;

a unit configured to generate second image data; and

a unit configured to generate data including the first image data and the second image data as the image data of the specimen, wherein:

the first image data is generated by the unit configured to generate the first image data by the imaging and the image processing by using the exposure amount and a parameter of the image processing to be determined while permitting provision of different values for each of distinct pieces of the first image data on condition that pixel values of pixels corresponding to portions of the specimen having an identical transmittance have an identical value in relation to all pieces of the first image data to be generated; and

the second image data is generated by the unit configured to generate the second image data by the imaging and the image processing by using the exposure amount and a parameter of the image processing to be adaptively determined on the basis of a feature of the specimen for each of distinct pieces of the second image data to be generated, and the display data generating apparatus comprising:

a unit configured to acquire the image data of the specimen including the first image data and the second image data from the imaging apparatus; and a unit configured to further generate, in addition to display screen data for presenting an image based on the second image data, at least any one of display screen data for presenting an image based on the first image data and display screen data for presenting both of the image based on the first image data and the image based on the second image data.

The present invention resides in an imaging system comprising:

an imaging apparatus for acquiring image data of a specimen by applying an image processing to imaging data obtained by imaging for the specimen by means of an imaging device while controlling an exposure amount determined by an exposure time and an incoming light amount per unit time allowed to come into the imaging device; and

a display data generating apparatus for generating display screen data for presenting, to a user by a display apparatus, an image based on the image data of the specimen acquired by the imaging apparatus, the imaging apparatus comprising:

a unit configured to generate second image data;

a unit configured to generate third image data; and

a unit configured to generate data including the second image data and the third image data as the image data of the specimen, wherein:

the second image data is generated by the unit configured to generate the second image data by the imaging and the image processing by using the exposure amount and a parameter of the image processing to be adaptively determined on the basis of a feature of the specimen for each of distinct pieces of the second image data to be generated; and

the third image data is generated from the second image data by the unit configured to generate the third image data by acquiring information of the exposure amount and the parameter of the image processing used to generate the second image data and performing an image processing which corresponds to inverse transformation of the imaging based on the exposure amount and an image processing which corresponds to inverse transformation of the image processing based on the use of the parameter of the image processing, and the display data generating apparatus comprising:

a unit configured to acquire the image data of the specimen including the second image data and the third image data from the imaging apparatus; and a unit configured to further generate, in addition to display screen data for presenting an image based on the second image data, at least any one of display screen data for presenting an image based on the third image data and display screen data for presenting both of the image based on the third image data and the image based on the second image data.

The present invention resides in a computer program stored on a non-transitory computer readable storage medium for controlling an imaging apparatus for acquiring image data of a specimen by applying an image processing to imaging data obtained by imaging for the specimen by means of an imaging device while controlling an exposure amount determined by an exposure time and an incoming light amount per unit time allowed to come into the imaging device, wherein the program allows the imaging apparatus to execute:

a step of generating first image data;

a step of generating second image data; and

a step of generating data including the first image data and the second image data as the image data of the specimen, and wherein:

the first image data is generated in the step of generating the first image data by the imaging and the image processing by using the exposure amount and a parameter of the image processing to be determined while permitting provision of different values for each of distinct pieces of the first image data on condition that pixel values of pixels corresponding to portions of the specimen having an identical transmittance have an identical value in relation to all pieces of the first image data to be generated; and

the second image data is generated in the step of generating the second image data by the imaging and the image processing by using the exposure amount and a parameter of the image processing to be adaptively determined on the basis of a feature of the specimen for each of distinct pieces of the second image data to be generated.

The present invention resides in a computer program stored on a non-transitory computer readable storage medium for controlling an imaging apparatus for acquiring image data of a specimen by applying an image processing to imaging data obtained by imaging for the specimen by means of an imaging device while controlling an exposure amount determined by an exposure time and an incoming light amount per unit time allowed to come into the imaging device, wherein the program allows the imaging apparatus to execute:

a step of generating second image data;

a step of generating third image data; and

a step of generating data including the second image data and the third image data as the image data of the specimen, and wherein:

the second image data is generated in the step of generating the second image data by the imaging and the image processing by using the exposure amount and a parameter of the image processing to be adaptively determined on the basis of a feature of the specimen for each of distinct pieces of the second image data to be generated; and

the third image data is generated from the second image data in the step of generating the third image data by acquiring information of the exposure amount and the parameter of the image processing used to generate the second image data and performing an image processing which corresponds to inverse transformation of the imaging based on the exposure amount and an image processing which corresponds to inverse transformation of the image processing based on the use of the parameter of the image processing.

The present invention resides in a computer program stored on a non-transitory computer readable storage medium for controlling a display data generating apparatus for generating display screen data for presenting, to a user by a display apparatus, an image based on image data of a specimen acquired by an imaging apparatus for acquiring the image data of the specimen by applying an image processing to imaging data obtained by imaging for the specimen by means of an imaging device while controlling an exposure amount determined by an exposure time and an incoming light amount per unit time allowed to come into the imaging device, wherein the program allows the display data generating apparatus to execute:

a step of acquiring the image data of the specimen including first image data and second image data from the imaging apparatus or a storage device; and

a step of further generating, in addition to display screen data for presenting an image based on the second image data, at least any one of display screen data for presenting an image based on the first image data and display screen data for presenting both of the image based on the first image data and the image based on the second image data, and wherein:

the first image data is image data which is generated by the imaging and the image processing by using the exposure amount and a parameter of the image processing to be determined while permitting provision of different values for each of distinct pieces of the first image data on condition that pixel values of pixels corresponding to portions of the specimen having an identical transmittance have an identical value in relation to all pieces of the first image data; and

the second image data is image data which is generated by the imaging and the image processing by using the exposure amount and a parameter of the image processing to be adaptively determined on the basis of a feature of the specimen every time when the second image data is generated.

The present invention resides in a computer program stored on a non-transitory computer readable storage medium for controlling a display data generating apparatus for generating display screen data for presenting, to a user by a display apparatus, an image based on image data of a specimen acquired by an imaging apparatus for acquiring the image data of the specimen by applying an image processing to imaging data obtained by imaging for the specimen by means of an imaging device while controlling an exposure amount determined by an exposure time and an incoming light amount per unit time allowed to come into the imaging device, wherein the program allows the display data generating apparatus to execute:

a step of acquiring second image data and information of the exposure amount and a parameter of the image processing used to generate the second image data from the imaging apparatus or a storage device;

a step of generating third image data from the second image data by performing, based on the use of the parameter of the image processing on the basis of the exposure amount and the parameter of the image processing, an image processing which corresponds to inverse transformation of the imaging based on the exposure amount and an image processing which corresponds to inverse transformation of the image processing with respect to the second image data; and

a step of further generating, in addition to display screen data for presenting an image based on the second image data, at least any one of display screen data for presenting an image based on the third image data and display screen data for presenting both of the image based on the third image data and the image based on the second image data.

### Advantageous Effects of Invention

According to the present invention, the user can easily judge whether any abnormality, which is found in an image, is something brought about by an abnormality existing in a specimen or any artifact resulting from an image processing, when the user observes image data obtained by the imaging by means of an imaging apparatus. Further features of the present invention will become apparent from the following description of exemplary embodiments with reference to the attached drawings.

### BRIEF DESCRIPTION OF DRAWINGS

FIG. 1 schematically shows an exemplary display screen of a viewer according to an embodiment.

FIG. 2 schematically shows an exemplary display screen of the viewer according to the embodiment.

FIG. 3 schematically shows an exemplary display screen of the viewer according to the embodiment.

FIG. 4 schematically shows an exemplary display screen of the viewer according to the embodiment.

FIG. 5 shows a block diagram illustrating a construction of a digital microscope system.

FIG. 6 shows a flow chart illustrating a method for acquiring image data according to the embodiment.

FIG. 7 shows a relationship between the transmittance of a slide (preparation or prepared specimen) and the output of an imaging device.

FIG. 8 shows an exemplary characteristic of the gradation transformation (gray level transformation or gray scale conversion) table.

FIG. 9 shows an exemplary histogram of image data.

FIG. 10 shows an exemplary characteristic of the gradation transformation table.

FIG. 11 shows a flow chart illustrating an outline of a processing of software of the viewer.

FIG. 12 schematically shows a display screen of a conventional viewer.

### DESCRIPTION OF EMBODIMENTS

An embodiment of the present invention will be explained in detail on the basis of the drawings. The embodiment of the present invention resides in such a digital microscope system that an image, which is based on image data obtained by the imaging by means of an imaging apparatus, can be observed by using a viewer. At first, an explanation will be made about the operation of the viewer of the digital microscope system of the embodiment of the present invention while making comparison with a conventional technique.

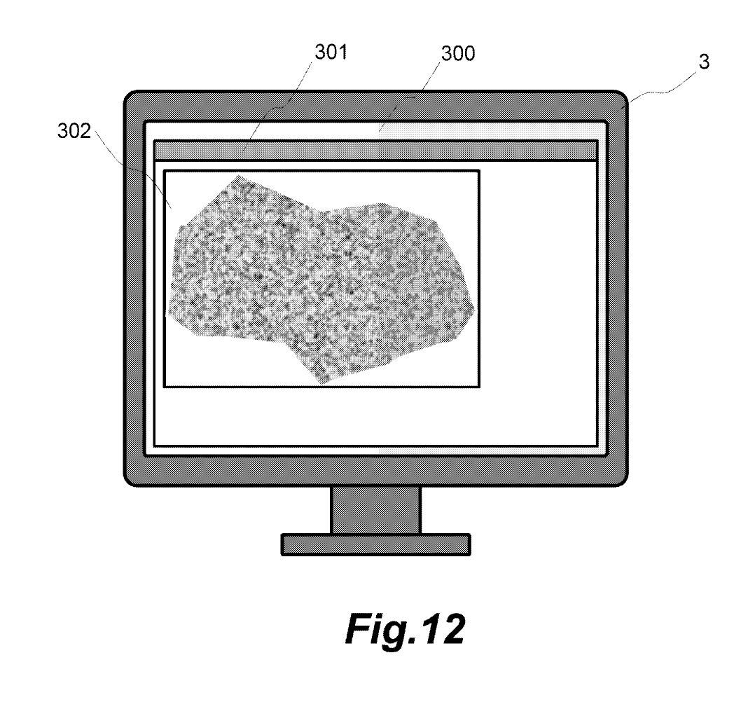

FIG. 12 schematically shows an exemplary display screen of a viewer of a conventional digital microscope system. With reference to FIG. 12, an application window 301 of the viewer is displayed in a display area 300 of a display apparatus 3. A main display area 302, in which image data designated as an observation objective by an observer is displayed, is disposed in the application window 301. The image data obtained by the imaging is displayed in the main display area 302 under the display condition (for example, the display range, the display position, and the display magnification) designated by the observer. The observer inputs the instruction to change the display condition by means of an input device (for example, an unillustrated keyboard and/or a pointing device such as mouse, track pad or the like) connected to the system. Accordingly, the image data can be observed while appropriately changing the display condition to perform, for example, the diagnosis.

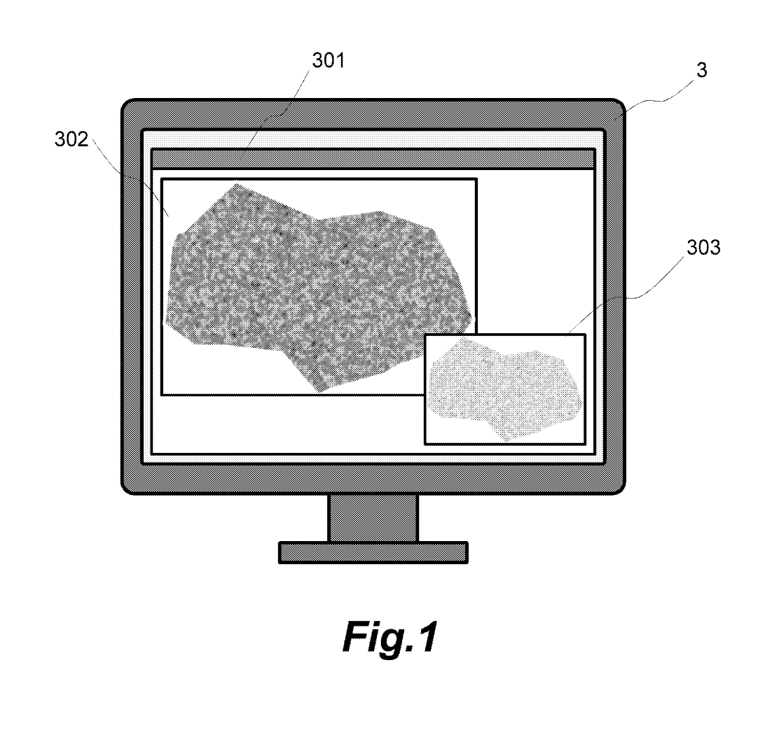

Next, an explanation will be made about the operation of the viewer of the digital microscope system of the embodiment of the present invention. FIG. 1 schematically shows an exemplary display screen of the viewer of the digital microscope system of the embodiment of the present invention. In FIG. 1, the same reference numerals and the same names are used for the constitutive elements which are equivalent to the constitutive elements of the viewer explained with reference to FIG. 12, and any explanation thereof will be omitted. With reference to FIG. 1, a subsidiary display area 303 is disposed in an application window 301 of the viewer. Image data, which is provided to confirm the preparation state (for example, the concentration (density) of the staining, the dispersion of the staining, and the dispersion of the specimen thickness) of a slide (preparation or prepared specimen), is displayed in the subsidiary display area 303. In the exemplary display shown in FIG. 1, the image data, which has the same display position and the same display range as those of the image data displayed in a main display area 302, is displayed in the subsidiary display area 303 by the viewer.

In the embodiment of the present invention, the image data, which is obtained by applying the image processing to provide a preferred image quality in order to perform the observation by the observer with respect to the image data obtained by the imaging while optimizing the exposure amount by the imaging apparatus, is displayed in the main display area 302. The image processing as described above includes the processing to improve the contrast and the processing to improve the dynamic range. When the image processing is applied as described above to the image data obtained by the imaging by the imaging apparatus, even if the preparation state of the slide is unsatisfactory, then it is possible to obtain the image data with which the observation can be performed with ease. For example, when the concentration of the staining is too thick, the image data is brightened by increasing the light amount of an unillustrated illumination apparatus, lengthening the exposure time of the imaging device, and/or decreasing the diaphragm (stop) value of the optical system to increase the exposure amount. The exposure amount herein refers to the value which is obtained such that the incoming light amount per unit time allowed to come into the imaging device, which is determined, for example, by the brightness of the illumination and the diaphragm (stop) of the optical system, is integrated with respect to the exposure time of the imaging device.

Further, when the concentration of the staining is too thick, then the dynamic range is narrow while being concentrated on the low luminance area in relation to the histogram of the image data in a state in which no image processing is applied, and it is difficult to perform the observation in some cases. In such a situation, the dynamic range can be enlarged by performing the gradation transformation (gray level transformation or gray scale conversion) as the image processing, and thus it is possible to prepare the image data with which it is easy to perform the observation. In this context, the mechanism, which is provided to vary the diaphragm (stop) value of the optical system in the present invention, is not limited to the diaphragm (stop) mechanism. It is also allowable to use, for example, a mechanism in which NA (Numerical Aperture) of the optical system itself is varied.

On the other hand, the image data, which is adjusted to have an easily observable image quality (to which the image processing is applied to provide the high image quality), has the good visual recognition performance to be observed with ease, but the image data sometimes suffers from the occurrence of any artifact resulting from the image processing. In the image diagnosis, the observer cannot decide in some cases whether the portion, which seems to be abnormal, is something caused by any abnormality existing in a specimen or any artifact resulting from the image processing. Such a situation may be a factor of the erroneous diagnosis. In view of the above, in the embodiment of the present invention, the image data, in which any image processing to provide a high image quality is not applied to the image data obtained by the imaging with a fixed exposure amount by means of the imaging apparatus, is displayed in the subsidiary display area 303. The image data as described above does not include any artifact resulting from the image processing to provide the high image quality. In the case of the image data as described above, the exposure amount is fixed, and the feature of the image, which results from the preparation state of the slide, is not corrected. Therefore, the image data as described above is excellent in the visual reorganization performance in order to confirm the preparation state of the slide. The observer can see the image which has the same display position and the same display range as those of the image displayed in the main display area 302, which has the fixed exposure amount, and which is not subjected to the image processing to provide the high image quality, while being displayed in the subsidiary display area 303 so that comparison may be made with each other. As a result, it is possible to judge whether or not the portion, which seems to be abnormal, is any artifact. Therefore, it is possible to suppress the erroneous diagnosis.

Of course, it is affirmed that one of the reliable methods is to confirm the preparation state by allowing the observer to actually see the slide. However, for example, when the observer is separated far from a hospital or the like in which the slide is stored on account of, for example, the telemedicine, it is impossible to actually see the slide. Further, when the sample is observed with the viewer after the time has elapsed, the slide is not stored in some cases. Also in this case, it is impossible to actually see the slide. The present invention is especially effective in the situations as described above.

The image data, which is to be displayed in the main display area 302, which is obtained by the imaging with an exposure amount adapted to the specimen, to which the image processing is applied to provide a high image quality, and which is appropriately adjusted for allowing the observer to perform the observation, is herein referred to as “second image data”. On the other hand, the image data, which is to be displayed in the subsidiary display area 303, which is obtained by the imaging with a fixed exposure amount, to which the image processing is not applied to provide a high image quality, and which is adequate to confirm the preparation state of the slide, is referred to as “first image data”. In order that the preparation state of the slide can be adequately or properly confirmed, it is preferable that condition for forming the image data (exposure amount, image processing), under which the first image data is to be acquired from the output signal fed from the imaging device, is common to the respective executions of the imaging (condition for forming the image data is identical in relation to the identical imaging apparatus). More preferably, it is appropriate to provide the condition for forming the image data which is standardized irrelevant to the imaging apparatus and the manufacturer. Further, it is preferable that the condition for forming the image data is unified by the condition for forming the first image data as described later on. When the standardization is achieved as described above, the observer can accurately confirm the preparation state of the slide by seeing or observing the first image data.

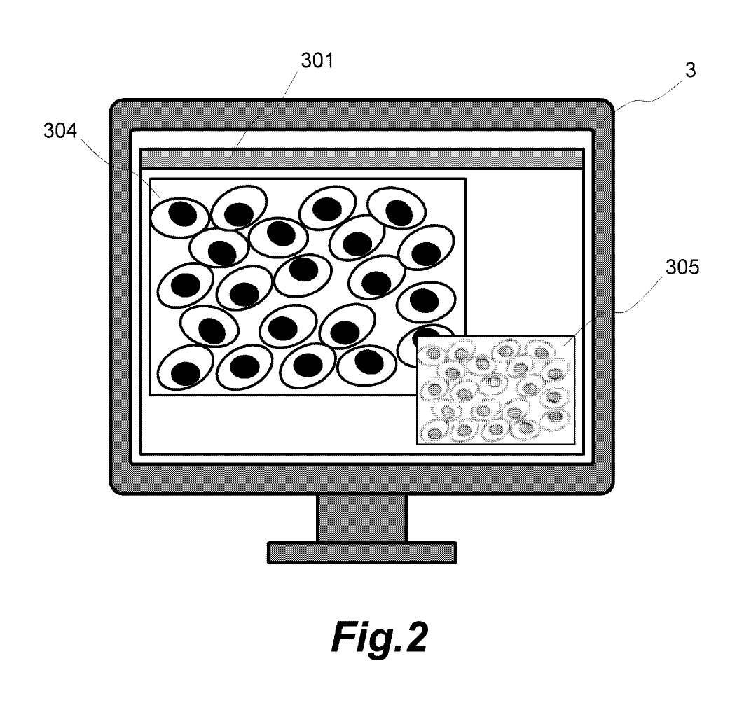

An explanation will be further made with reference to FIG. 2 about an exemplary operation of the viewer of the embodiment of the present invention. FIG. 2 schematically shows an exemplary display screen of the viewer of the embodiment of the present invention. In FIG. 2, the reference numerals, which have been explained with reference to FIGS. 12 and 1, are omitted from the explanation. With reference to FIG. 2, the main display area 304 is disposed in the application window 301 of the viewer. The image data, which is obtained by the imaging with an exposure amount adapted to a specimen as the observation objective (sample, slide) and which is subjected to the image processing to provide a high image quality suitable for the observation, is displayed in the main display area 304. The subsidiary display area 305 is disposed in the application window 301 of the viewer to display the image data which is suitable to confirm the preparation state of the slide, which is obtained by the imaging with a fixed exposure amount, and which is not subjected to the image processing. FIGS. 1 and 2 are common in that the application window 301 of the viewer is constructed to include the main display area and the subsidiary display area, but the images, which are displayed in the respective display areas, are different therebetween. Therefore, the different reference numerals are used. In FIG. 2, the display condition, which is provided for the second image data displayed in the main display area 304, has the high display magnification as compared with the example shown in FIG. 1 in accordance with the instruction of the observer. The first image data, which has the same display magnification and the same display position as those of the second image data displayed in the main display area 304, is displayed in the subsidiary display area 305 in the same manner as in FIG. 1.

In this way, the second image data is displayed in the main display area 304, and the first image data is displayed in the subsidiary display area 305. Thus, the observer can perform the diagnosis by using the second image data adjusted to provide the image quality with which the observation can be performed with ease in the same manner as in FIG. 1. If any portion, for which the artifact is suspected, is present, the observer can confirm the preparation state of the slide to enhance or raise the diagnosis accuracy by inputting the instruction to display the first image data in the subsidiary display area 305. In this procedure, in the case of the display condition in which the display magnification is high as shown in FIG. 2, it is impossible to observe a wide range of the slide even when the observer sees the second image data displayed in the subsidiary display area 305. Therefore, it is sometimes difficult to grasp the preparation state of the slide.

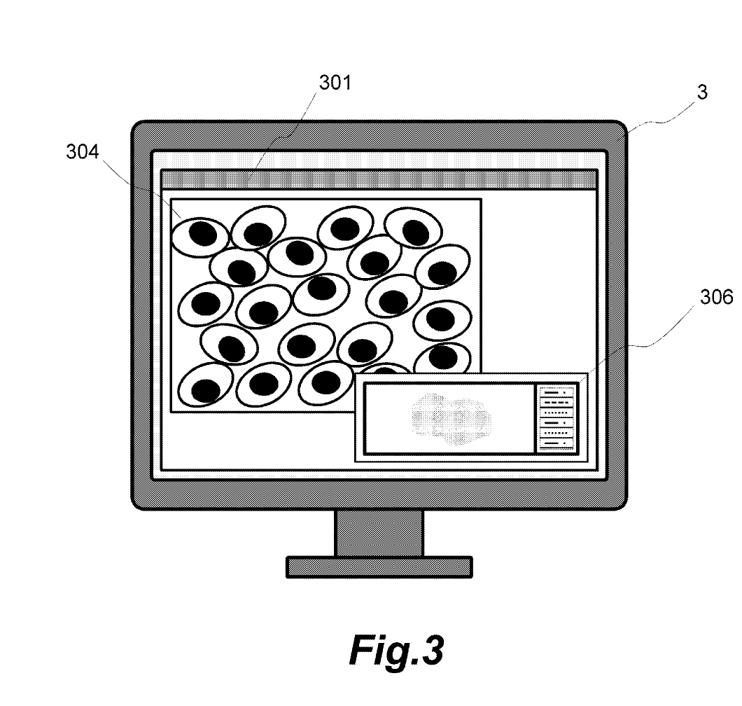

In view of the above, as shown in FIG. 3, it is also appropriate that the first image data, in which the entire slide is subjected to the imaging, is displayed in the subsidiary display area 306. FIG. 3 schematically shows an exemplary display screen of the viewer of the embodiment of the present invention. In FIG. 3, the reference numerals, which have been explained with reference to FIGS. 12, 1, and 2, are omitted from the explanation. With reference to FIG. 3, the subsidiary display area 306, in which the first image data is displayed, is disposed in the application window 301 of the viewer. The first image data, which is displayed in the subsidiary display area 306 in FIG. 3, is the first image data in which the entire slide is subjected to the imaging beforehand by using, for example, a digital microscope. That is, in the case of the exemplary display shown in FIG. 3, the display condition (display position, display range, display magnification) differs between the main display area 304 and the subsidiary display area 306. The first image data, in which the imaging is performed for the entire slide or the slide in a wide range to such an extent that the preparation state of the slide can be appropriately confirmed, is displayed in the subsidiary display area 306 irrelevant to the display condition of the second image data displayed in the main display area 304. As a result, the observer can easily grasp the preparation state of the slide in the subsidiary display area 306. Of course, in this case, the concept can be embodied more conveniently when the imaging device for acquiring the first image data is different from the imaging device and/or the magnifying optical system (lens) for acquiring the second image data.

It is also allowable that the change or switching can be performed between the display in which the display condition for the first image data displayed in the subsidiary display area is identical with the display condition for the second image data displayed in the main display area and the display (display of the entire slide) in which the subsidiary display area has a wider display range, in accordance with the instruction of the observer.

The operation of the viewer of the embodiment of the present invention as explained above is performed such that the first image data is displayed in the subsidiary display area by receiving the instruction of the observer. In this procedure, the first image data is displayed in the subsidiary display area only when the display is required in accordance with the instruction of the observer. Accordingly, an advantage is obtained such that the preparation state of the slide can be confirmed. In this construction, in order to confirm the preparation state of the slide by displaying the first image data, it is necessary that the observer should give the instruction to display the first image data in the subsidiary display area. If the observer does not suspect the possibility of any artifact in the diagnosis based on the second image data, in other words, if the observer cannot recognize the necessity to confirm the preparation state of the slide, then the display of the first image data is not performed. Therefore, even in the case of the image diagnosis based on the same image data, the contents of the observation may be changed depending on the observer, and any dispersion may arise in the diagnosis accuracy.

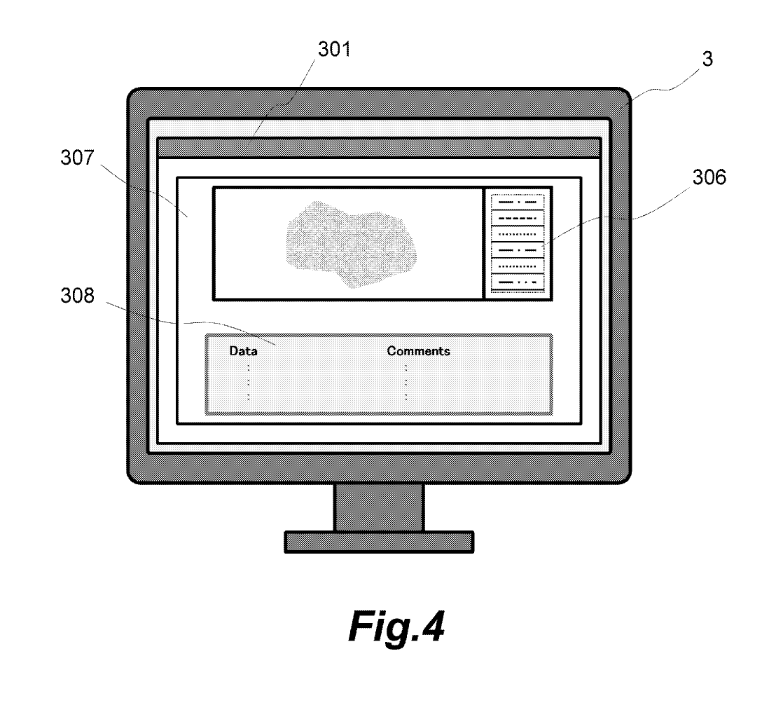

In view of the above, it is preferable that an initial screen window 307 as shown in FIG. 4 is displayed on the application window 301 when the display of a new slide is instructed by the observer or when the observer is changed. A subsidiary display area 306 and an information display window 308 are provided in the initial screen window 307. The entire slide is displayed by using the first image data in the subsidiary display area 306, and the information, which relates to the slide, is displayed in the information display window 308. FIG. 4 schematically shows an exemplary display screen of the viewer of the embodiment of the present invention. In FIG. 4, the reference numerals, which have been explained with reference to FIGS. 12, 1, 2, and 3, are omitted from the explanation. It is preferable to provide such a mechanism that the user information of the observer is inputted, for example, when the application of the viewer is started up, in order that the initial screen display shown in FIG. 4 is performed when the observer is changed even if the slide as the display objective is identical.

Accordingly, the first image data is firstly presented to the observer in order to confirm the preparation state of the slide without any intentional instruction of the observer. Therefore, the preparation state of the slide is necessarily confirmed on the initial screen irrelevant to the skill of the observer. Thus, it is possible to suppress the occurrence of any dispersion of the diagnosis accuracy, which would be otherwise caused depending on the observer.

### First Embodiment

An explanation will be made below about a first embodiment to realize the operation of the viewer as described above.

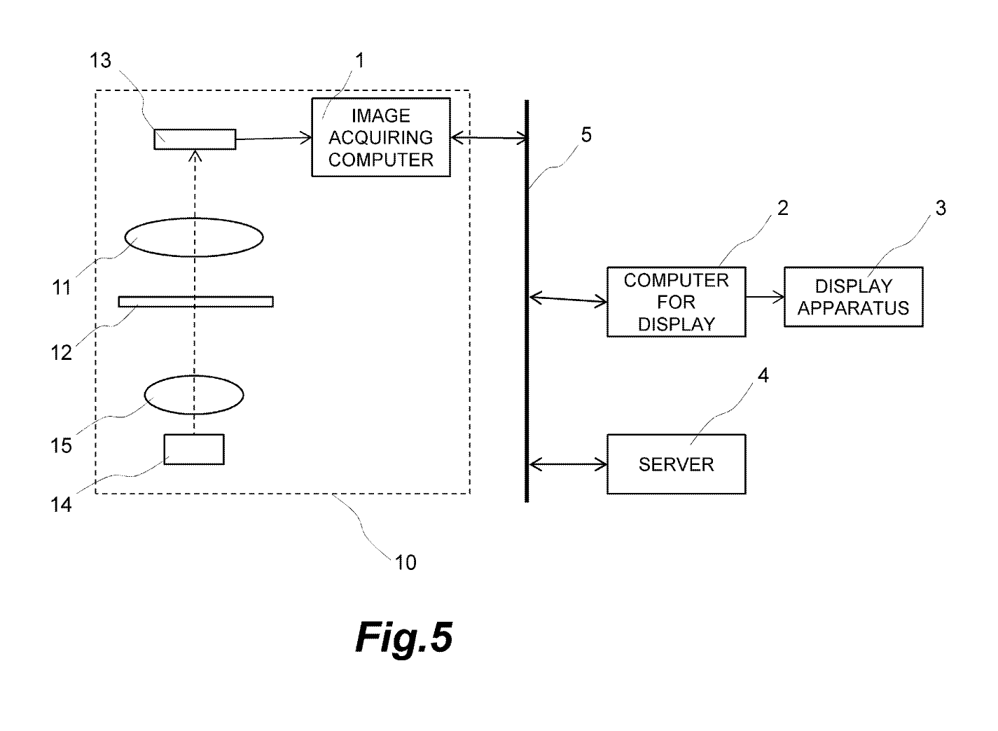

FIG. 5 shows a block diagram illustrating a construction of a digital microscope system according to the first embodiment. The digital microscope system of the first embodiment resides in an imaging system constructed by a computer for display 2, a server 4, and a digital microscope 10 which are connected to one another by a network 5. The digital microscope 10 is composed of an image acquiring computer 1 and an imaging unit. The imaging unit is constructed to include a microscope optical system 11, an imaging device 13, an illumination apparatus 14, and an illumination optical system 15 to perform the imaging for a specimen supported on a slide 12. A display apparatus 3, which is the output destination of the display screen data, is connected to the computer for display 2 which is the display data generating apparatus for outputting the display screen data of the viewer.

With reference to FIG. 5, the light, which is emitted by the illumination apparatus 14, is radiated onto the specimen of the slide 12 by means of the illumination optical system 15. The microscope optical system 11 is the imaging optical system which forms a real image on the imaging device 13 by magnifying an image of the specimen of the slide 12 at a predetermined magnification. The imaging device output, which is fed from the imaging device 13, is inputted into the image acquiring computer 1 which performs the image processing as described later on to prepare the image data that is transmitted to the server 4 via the network 5. The server 4 stores the image data, for example, in HDD or SSD. The computer for display 2 starts up the viewer described above to thereby prepare the display data (display screen data) for constructing the display screen as explained, for example, with reference to FIGS. 1, 2, 3, and 4, and the data is outputted to the display apparatus 3. The display apparatus 3 displays the display screen on the basis of the display data.

At first, an explanation will be made about the method for acquiring the first image data and the second image data described above. As described above, the first image data is generated under the fixed condition (fixed condition for forming the first image data) which is commonly applied to each of the executions of the imaging. On the other hand, the second image data is generated under the condition (condition for forming the second image data to be changed corresponding to the specimen) which is preferably adjusted in order to perform the observation depending on the specimen. The conditions will be explained in further detail.

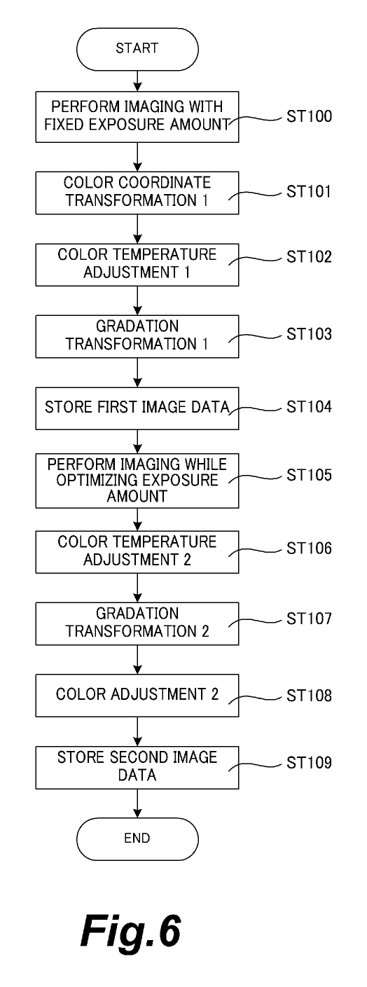

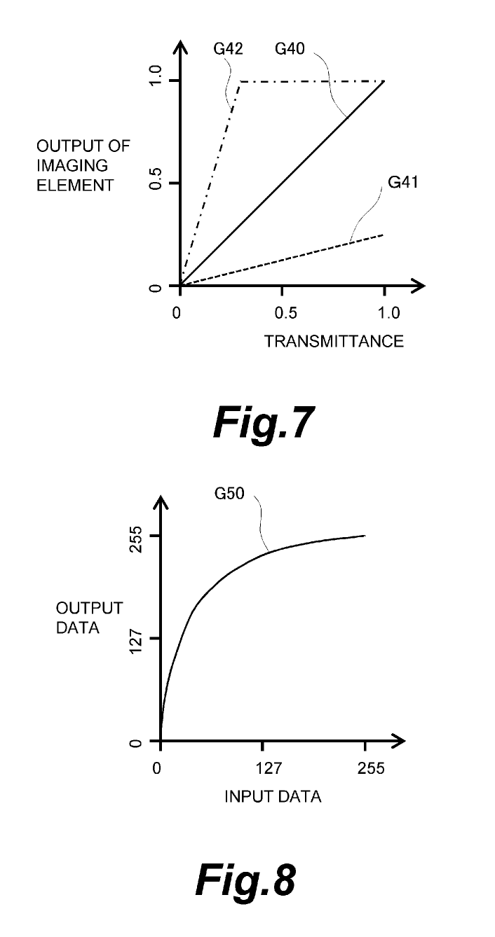

FIG. 6 shows a flow chart illustrating an exemplary method for acquiring the image data in the first embodiment. The processings, which are shown in the flow chart of FIG. 6, are executed by the image acquiring computer 1. The image acquiring computer 1 acquires the first image data and the second image data in accordance with the flow chart shown in FIG. 6. The image acquiring computer 1 acquires the imaging data with the fixed exposure amount in Step ST100. The imaging data is the data obtained by converting or transforming the output of the imaging device into the digital data. The imaging, which is performed while fixing the exposure amount in Step ST100, will be explained with reference to FIG. 7. FIG. 7 shows a graph illustrating the relationship between the transmittance of the slide and the output of the imaging device. In FIG. 7, the horizontal axis represents the normalized transmittance of the slide, and the vertical axis represents the normalized output of the imaging device. In the imaging performed while fixing the exposure amount (Step ST100), the exposure amount is fixed while performing the adjustment so that the relationship between the transmittance of the slide and the output of the imaging device exhibits a characteristic indicated by a straight line G40 shown in FIG. 7. The characteristic, which is indicated by the straight line G40 in FIG. 7, is such a characteristic that the output of the imaging device is 100% when the transmittance is 100%, i.e., when the slide 12 is detached or removed, wherein there is no deterioration of the signal and the S/N ratio is satisfactory. For example, in the case of a characteristic indicated by a straight line G41 shown in FIG. 7, the deterioration of the image quality, which would be caused by the restriction of the signal, is not caused, but the S/N ratio is low because the output of the imaging device is small. On the other hand, in the case of a characteristic indicated by a straight line G42 shown in FIG. 7, the output of the imaging device is saturated at a stage at which the transmittance of the slide 12 is small, and hence the gradation performance (gradation characteristic) is unsatisfactory and the image quality is deteriorated. In Step ST100, the light amount of the illumination apparatus 14, the unillustrated diaphragms (stops) of the illumination optical system 15 and the microscope optical system 11, and the exposure time of the imaging device 13 are adjusted and fixed. Further, the relationship between the transmittance of the slide and the output of the imaging device is intended to be the characteristic indicated by the straight line G40 shown in FIG. 7. Specifically, for example, if the relationship between the transmittance of the slide and the output of the imaging device, which is provided in the present circumstance, resides in the characteristic indicated by the straight line G41, the adjustment is performed so that the light amount of the illumination apparatus 14 is increased, followed by being fixed. If the relationship resides in the characteristic indicated by the straight line G42, the adjustment is performed so that the light amount of the illumination apparatus 14 is decreased, followed by being fixed.

In Step ST100, the exposure amount is fixed depending on the apparatus irrelevant to the specimen. Therefore, when the apparatus is determined, the imaging is performed with the fixed exposure amount.

The imaging data, which is obtained with the fixed exposure amount in accordance with Step ST100, is the data which has a color space determined by a characteristic of the imaging device 13 and a characteristic of a color filter, for example, in the case of the imaging device having the color filter of RGB. In Step ST101, the image acquiring computer 1 converts or transforms the color space into a color space of the display apparatus 3 or a normalized color space of RGB or the like, for example, in accordance with the matrix calculation (color coordinate transformation 1). If necessary, the image acquiring computer 1 performs the color temperature adjustment 1 in Step ST102. The color temperature adjustment 1 performed in Step ST102 may be a processing to faithfully reproduce the color temperature of the illumination upon the imaging or a processing to perform the conversion or transformation into the color temperature of the display apparatus 3 irrelevant to the color temperature of the illumination upon the imaging. When the latter processing is performed, the difference in the color temperature of the illumination apparatus 14 of the digital microscope 10 disappears when the display is performed. However, it is considered that any special problem does not arise in order to confirm the preparation state of the slide. On the other hand, when the former processing is performed, the difference in the color temperature of the illumination apparatus 14 is correctly displayed. However, in this case, it is sometimes difficult for the observer to confirm the preparation state of the slide due to the difference in the color temperature of each of the slides. Subsequently, in Step ST103, the transformation is performed to provide the characteristic to counteract the gradation characteristic of the display apparatus 3 in accordance with the gradation table. For example, the transformation is performed to provide the normalized gradation characteristic such as sRGB or the like (gradation transformation 1). The gradation transformation 1, which is performed in Step ST103, can be realized, for example, by using the gradation table having the characteristic shown in FIG. 8. FIG. 8 shows a graph illustrating the characteristic of the gradation transformation table adapted to the sRGB standard. The horizontal axis of FIG. 8 represents the input data of the gradation transformation table, and the vertical axis represents the output data. In this case, for example, the data is exemplified, which has a bit width of 8 bit. The bit width of the data may have any other value. The characteristic G50 shown in FIG. 8 is the gradation characteristic required by the sRGB standard (characteristic of 1/2.2th power). It is expected that the display of the linear gradation characteristic is provided when the display apparatus of the sRGB standard having the 2.2th power gradation characteristic is used. The first image data, which is adequate to confirm the preparation state of the slide, is generated in accordance with the processings of Step ST100 to Step ST103.

The condition of the processings of Step ST100 to Step ST103 is referred to as “condition for forming the first image data”. In this context, the condition of the processings of Step ST100 to Step ST103 is fixed irrelevant to the specimen, and the image acquiring computer 1 acquires the first image data by always using the same condition for forming the first image data. Subsequently, in Step ST104, the image acquiring computer 1 outputs the first image data generated in the processings of the respective steps described above via the network 5 to the server 4, and the data is stored, for example, in HDD or SSD of the server 4. On the other hand, the exposure amount may be fixed, for example, so as to provide the characteristic indicated by G41 shown in FIG. 7 in Step ST100. In this case, the image processing is performed to multiply a coefficient in the matrix calculation of the color coordinate transformation at the downstream stage to obtain the first image data so that the output of the image data is 1 (normalization) with respect to the transmittance of 1 (normalization) of the slide. Further, it is intended to confirm the preparation state of the slide. Therefore, it is also allowable to provide a combination of the exposure amount and the image processing so that the output of the image data is constant if the specimen of the slide has the same transmittance. That is, the first image data may be the image data which is generated by the imaging and the image processing by using the exposure amount and the parameter of the image processing determined as follows. That is, the exposure amount and the parameter of the image processing are determined while permitting provision of different values for each of distinct pieces of the first image data on condition that the pixel values of pixels corresponding to portions of the specimen having an identical transmittance have an identical value in relation to all pieces of the first image data to be generated. In this case, it is also considered that the exposure amount (for example, the diaphragm (stop), the exposure time, and NA) and the parameter of the image processing (condition for forming the first image data) are not fixed, but they differ for each of distinct pieces of the first image data in some cases. However, the relationship between the transmittance of the specimen and the pixel value corresponding thereto, i.e., the relationship between the input and the output is common to all pieces of the first image data. An explanation may be made by using a simple example as follows. That is, if the exposure amount of the first image data A is 2, and the gain of the image processing is 1, then it is appropriate that the exposure amount of the first image data B is 1 and the gain of the image processing is 2. When the relationship between the transmittance of the specimen to serve as the photographic subject and the pixel value of the image data is constant as described above, it is permitted that the combination (condition for forming the first image data) of the exposure amount and the parameter of the image processing differs for each of distinct pieces of the first image data. As for the term “permit” or “permitted”, it is not necessarily indispensable that the condition for forming the first image data differs for all pieces of the first image data. The condition for forming the first image data may mutually differ between part of pieces of the first image data, and the condition for forming the first image data may be common to the other pieces of the first image data. The phrase “pixel values of pixels corresponding to portions of the specimen having an identical transmittance have an identical value in relation to all pieces of the first image data to be generated”, which is referred to in the present invention, indicates the concept as described above. Usually, the imaging device 13 has, for example, the dispersion of offset accompanied by the noise and/or the dark current. However, the “condition”, which is referred to in the present invention, represents the condition provided when the dispersion of offset or the like, which is accompanied by the noise and/or the dark current as described above, is excluded (in the case of an ideal situation). Therefore, the phrase “pixel values of pixels corresponding to portions of the specimen having an identical transmittance have an identical value in relation to all pieces of the first image data to be generated”, which is referred to in the present invention, includes not only the case in which the pixel values have exactly the same value but also the case in which the pixel values differ by an amount of error.

Subsequently, in Step ST105, the exposure amount is adjusted to an optimum exposure amount adapted to the specimen to perform the imaging. For example, when the staining is thick, then the exposure amount is increased and the S/N ratio of the image data is made satisfactory to perform the imaging. In Step St106, Step ST107, and Step ST108, the image acquiring computer 1 performs the image processings (color temperature adjustment 2, gradation transformation 2, color adjustment 2) under the condition determined to perform the transformation to provide the image quality with which the observer can perform the observation with ease, and thus the second image data is generated. In Step St105 to Step ST108, the exposure amount is based on the feature of the specimen, and the condition for the image processing is the condition determined adaptively on the basis of the feature of the image data in accordance with the analysis of the imaging data. The condition is herein referred to as “condition for forming the second image data”. Specifically, in Step ST105, the exposure amount is adaptively adjusted depending on the concentration of the specimen. In Step ST106 and Step ST108, the image acquiring computer 1 adjusts the image data to provide the color and the color temperature with which the observer can perform the observation with ease.

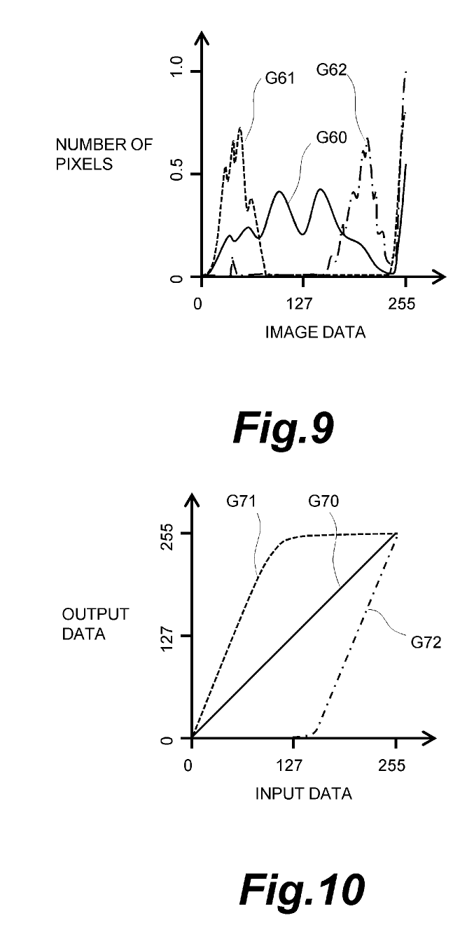

For example, the image acquiring computer 1 performs the image processing so as to correct the dispersion of the hue (tone) and the color thickness of the staining of every slide and the difference in the color temperature caused by the transmittance distribution of the glass of the slide and/or any exclusively usable sealing agent such as synthetic resin or the like. In the gradation transformation 2 in Step ST107, the image acquiring computer 1 performs the image processing to correct, for example, the 100% black, totally underexposed situation caused by the thickness of the specimen and the dispersion of the staining process and the distribution of the histogram. An explanation will be made in further detail with reference to FIGS. 9 and 10. FIG. 9 shows an exemplary histogram of the image data. FIG. 10 shows an exemplary characteristic of the gradation transformation (gray level transformation or gray scale conversion) table of the gradation transformation 2 in Step ST107.

A histogram G60 (solid line) shown in FIG. 9 is an example of the image data obtained by the imaging for a specimen stained satisfactorily, which is the histogram having less distribution. In this case, the image data can be observed sufficiently easily even when any special gradation transformation is not performed. Therefore, the image acquiring computer 1 performs the gradation transformation indicated by a characteristic G70 (solid line) shown in FIG. 10 (transformation of the characteristic G70 is the transformation to output the input as it is). A histogram G61 (dotted line) shown in FIG. 9 is an example of the image data which includes many areas obtained by the imaging for a specimen stained too thick or having a thick thickness. If the display is performed as it is, then the display is too dark, and hence it is difficult to perform the observation. Therefore, the image acquiring computer 1 performs the gradation transformation indicated by a characteristic G71 (dotted line) shown in FIG. 10. Accordingly, it is possible to generate the second image data having a wide dynamic range with which the observation can be performed with ease. A histogram G62 (alternate long and short dash line) shown in FIG. 9 is an example of the image data obtained by the imaging for a specimen stained too thin. If the display is performed as it is, then greater parts of the specimen are concentrated on bright areas, the display is provided such that the luminance difference is indistinct and there is no contrast, and hence it is difficult to perform the observation. Therefore, the gradation transformation is performed as indicated by a characteristic G72 (alternate long and short dash line) shown in FIG. 10. Accordingly, it is possible to generate the second image data in which the dynamic range is wide and it is easy to perform the observation.

Finally, in Step ST109, the image acquiring computer 1 outputs the second image data generated in the processings in the respective steps described above via the network 5 to the server 4, and the data is stored, for example, in HDD or SSD of the server 4.

As for the adjustment to provide the optimum exposure amount adapted to the specimen and the image processing determined adaptively on the basis of the feature of the imaging data as explained above, it is also allowable that both of them may be performed, or the second image data may be generated by performing only any one of them, if the image, which is felt by the observer to be satisfactory, is obtained.

The image data, which is required for the virtual slide, is generated from a plurality of pieces of the imaging data obtained by the imaging for the specimen a plurality of times in a divided manner while changing at least any one of the imaging position of the specimen, the imaging range of the specimen, and the magnifying magnification of the image of the specimen. The processings of the flow chart shown in FIG. 6 are performed for each of the executions of imaging of the plurality of pieces of the imaging data respectively.

In this description, the exemplary case has been explained, in which both of the first image data and the second image data are generated. However, in such a procedure, the capacity of the storage device for storing the image data, which is twice the capacity required for the conventional technique, is required. In order to reduce the capacity required for the storage device, it is also allowable that only the first image data, which corresponds to part of the second image data, is stored without storing the first image data which corresponds to all of the second image data. The first image data is the image data which is used to confirm the preparation state of the slide. As described above, the image data of the high magnification is not necessarily preferred for this purpose. Therefore, it is also allowable to store only the first image data which is obtained by the imaging at a low magnification and/or only the first image data which is obtained by photographing the entire slide. In particular, it is also allowable that only the image data, which is obtained by photographing the entire slide, is stored as the first image data. In this procedure, the transmission photographing is not premised for the label portion of the slide, and a non-transmissive member is used for the label portion in some cases.

When the digital microscope 10, which is constructed for the transmission photographing, is used to generate the image data in which the entire slide is photographed, it is appropriate that the image processing or the like is performed for the label portion so that letters or the like of the label portion can be distinguished or identified. In another method, it is also appropriate that an illumination unit, which illuminates the label portion, is provided on the side of the microscope optical system 11 so that the label can be subjected to the imaging. When an imaging apparatus, which captures an image of the entire slide, is provided distinctly from the digital microscope 10, then an illumination is provided on the side opposite to the imaging side because the transmitted light is utilized for those other than the label portion, and an illumination is provided on the imaging side because the reflected light is utilized for the label portion. Steps ST100 to ST103 and Step ST104 shown in FIG. 6 are performed to acquire the first image.

When the second image data resides in the image photographed in a dark field, the imaging is performed while inserting a dark field condenser into the microscope optical system 11 of the digital microscope 10. In this case, the processings of ST100 to ST103 of the flow chart shown in FIG. 6 are performed in a state in which the dark field condenser is detached or removed, and thus the first image data is acquired. After that, the dark field condenser is inserted, the processings of ST105 to ST108 are performed, and thus the second image data is acquired. When the image data is acquired as described above, a long period of time is required to perform the imaging. Therefore, as described above, it is preferable that only the image, in which the entire slide is photographed, is generated and stored as the first image data. Similarly, in the case of the image data acquired by any method other than the transmission light imaging, it is also preferable that only the image, in which the entire slide is photographed, is used as the first image data.

In the flow chart shown in FIG. 6, the imaging is firstly performed while fixing the exposure amount to prepare the first image data, and then the imaging is performed with the optimum exposure amount to prepare the second image data. However, the preparation of the first image data and the second image data is not limited to this flow. For example, two pieces of image data may be calculated by the imaging once. That is, the imaging is performed while fixing the exposure amount in Step ST100, and the first image data is generated in Step ST101 to Step ST104. Subsequently, the second image data may be prepared in Step ST106 to Step ST109 while omitting Step ST105. That is, the value, which is used to generate the first image data, is used for the exposure amount in place of the execution of the optimization of the exposure amount and the optimization of the parameter of the image processing in order to obtain the second image data regulated to have the image quality which is adaptive and which makes it possible to perform the observation with ease. That is, there is such a possibility that the exposure amount is not optimized in relation to the easiness of the observation. Corresponding thereto, the regulation, which provides the image quality to make it possible to perform the observation with ease, is performed by means of only the optimization of the parameter of the image processing. For example, a specimen is assumed, for which the optimization is performed to realize the easy observation by providing an exposure amount of 2 in relation to the optimization of the exposure amount in Step ST105 described above and providing a gain of 1 in relation to the image processing parameter. On the other hand, it is assumed that the exposure amount is 1 for the imaging data used to generate the first image data. In this case, when the second image data is also generated by using the imaging data used to generate the first image data while omitting Step ST105, it is approved that the exposure amount of the imaging data is ½ of the optimum exposure amount. Therefore, the gain is set to 2 in relation to the parameter of the image processing. Accordingly, the second image data, which is optimized in relation to the easiness of the observation, can be consequently generated from the imaging data used to generate the first image data.

Next, the operation of the viewer of the first embodiment will be explained in detail.

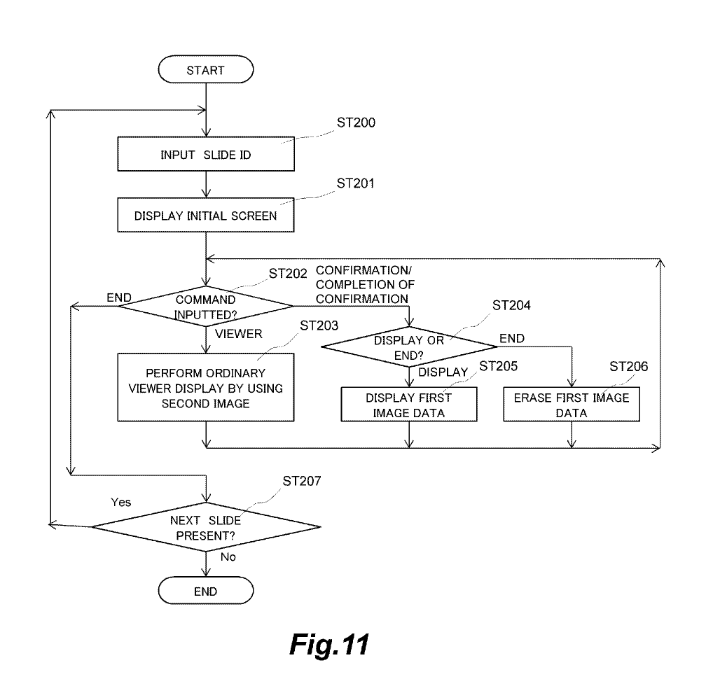

FIG. 11 shows a flow chart illustrating the outline of the processing procedure for the viewer executed by the computer for display 2.

The computer for display 2 prepares the display screen data from the first image data, the second image data, and various pieces of image data for constructing GUI such as the window or the like in accordance with the flow chart shown in FIG. 11, and the data is outputted to the display apparatus 3. The display apparatus 3 performs the image display on the basis of the inputted display screen data.

When the viewer is executed, the computer for display 2 allows the observer to input the identification information (ID) of the slide to be observed from now in Step ST200. The observer inputs ID of the slide intended to be observed, and the processing proceeds to the next step. This processing is the processing which is performed to specify the image data to be read from the server 4 by the computer for display 2. It is also allowable to adopt any other processing provided that this object is achieved. For example, if the order of the pieces of image data to be displayed is previously determined (i.e., if the image data to be displayed next is automatically specified if “Yes” is given in ST207 described later on), the processing of ST200 is omitted. In Step ST201, the computer for display 2 displays the initial screen as shown in FIG. 4 including, for example, the information display of the slide and the first image data in order to confirm the preparation state of the slide corresponding to ID of the slide inputted in ST200. It is also allowable that the display of the initial screen is omitted.

Subsequently, in Step ST202, the computer for display 2 waits for the input of the instruction command of the observer. If the inputted instruction command is the command to display only the second image data, the computer for display 2 proceeds to Step ST203 to perform the processing for displaying the second image data on the application window of the viewer. In Step ST203, the computer for display 2 performs the display processing corresponding to the display condition designated by the observer (for example, the display position, the display range, and the display magnification). The second image data, which is displayed in this case, is the image data which is generated by applying the image processing to provide the high image quality under the condition for forming the second image data so that the observer can perform the observation with ease.

In Step ST202, if the inputted instruction command is the command to instruct the completion of the observation of the slide observed at present, the computer for display 2 proceeds to Step ST207 to confirm, to the observer, whether the next slide is observed or the viewer is completed. If the observer gives the instruction to observe the next slide, the computer for display 2 returns to Step ST200 to wait for the input of ID of the slide. The operation is repeated thereafter in the same manner as described above. In Step ST207, if the observer gives the instruction to complete the viewer, the computer for display 2 completes the execution of the viewer. The input of the instruction command as described above can be performed, for example, such that the pointer, which is displayed on the application window, is moved by operating the mouse by the user so that the icon or the like of the menu is clicked. Alternatively, the input can be also performed by inputting the text by operating the keyboard by the user or depressing the function key of the keyboard to which the instruction command is allotted.

In Step ST202, if the inputted instruction command is the command to confirm the preparation state of the slide or complete the confirmation, the computer for display 2 proceeds to Step ST204.

In Step ST204, if it is judged that the instruction command, which is inputted in Step ST202, is the command to confirm the preparation state of the slide, the first image data is displayed in the subsidiary display area of the application window, for example, as shown in FIGS. 1, 2, and 3 (Step ST205). In this procedure, if the subsidiary display area is narrow as compared with the main display area for displaying the second image data, the main display area can be seen with ease. Therefore, the display of the second image data for the diagnosis can be seen with ease, which is preferred. If the screen size of the display apparatus 3 is wide, the size of the application window has a room or margin. Therefore, it is also appropriate that the main display area and the subsidiary display area have the same size. On the other hand, if the screen size of the display apparatus 3 is narrow, the size of the application window has no margin. Therefore, the second image data and the first image data may be displayed in the main display area while being changed or switched, without providing the subsidiary display area.

In Step ST204, if it is judged that the instruction command, which is inputted in Step ST202, is the command to complete the confirmation of the preparation state of the slide, the computer for display 2 ceases or stops the display of the first image data (Step ST206).

In accordance with the operation of the viewer executed by the computer for display 2 as explained above, the observer can confirm the preparation state of the slide in Step ST201 before observing the image data of the slide. If the observer cannot decide whether the portion, which appears to be abnormal in the observation of the image data, is something caused by any abnormality existing in the specimen or any artifact resulting from the image processing, it is possible to confirm the preparation state of the slide by using the first image data, if necessary. Therefore, according to the digital microscope system of the first embodiment, the image diagnosis can be performed efficiently, and it is possible to suppress the erroneous diagnosis.

In the digital microscope system of the first embodiment, the second image data, which is generated under the condition for forming the second image data as adaptively determined for each of the specimens so that the observer can perform the observation with ease, is presented as the image for the diagnosis to the observer. Further, the first image data, which is generated under the condition for forming the first image data as fixed irrelevant to the specimen in order to confirm the preparation state of the slide, is presented to the observer in response to the request of the observer. Further, the initial screen, which presents the corresponding first image data to the observer, is displayed before displaying the second image data by means of the viewer irrelevant to the presence or absence of the request of the observer.

As a result, when the user observes the image data obtained by the imaging by means of the imaging apparatus, the user can easily judge whether the abnormality, which is found in the image, is something caused by any abnormality existing in the specimen or any artifact resulting from the image processing. Therefore, it is possible to shorten the diagnosis time, and it is possible to reduce the erroneous diagnosis.

### Second Embodiment

A second embodiment will be explained. In the first embodiment described above, if the first image data is acquired corresponding to all pieces of the second image data, then the size of the image data as a whole is increased, and the capacity of the storage device, which is required to store the image data, is increased. The image data of the virtual slide has the large size. Therefore, the amount of increase in the whole size of the image data is large, which is caused by the increase in the first image data.

In view of the above, in the second embodiment, the third image data, which is equivalent to the first image data, is prepared from the second image data. Accordingly, it is unnecessary to store the first image data.

In the second embodiment, the first image data referred to in the first embodiment may be appropriately replaced with the third image data explained below. Therefore, a method for acquiring the third image data will be explained below.

As explained with reference to FIG. 6, in the first embodiment, the imaging is performed in relation to the first image data while optimizing the exposure amount in Step ST105 in order to provide the image quality with which the observer can perform the observation with ease, and the image processing is applied in Steps ST106, ST107, and ST108 to prepare the second image data. Therefore, the image data, which is equivalent to the first image data, can be generated from the second image data by performing the transformation (image processing corresponding to the inverse transformation) having the inverse characteristic with respect to the transformation performed in Steps ST106, ST107, and ST108 as well as the execution with the exposure amount in Step ST105. In the second embodiment, the image data, which is equivalent to the first image data of the first embodiment and which is generated from the second image data by performing the inverse transformation of the image processing for generating the second image data as described above, is referred to as “third image data”. The image processing is irreversible transformation in some cases. The first image data of the first embodiment is not strictly the same as the third image data of the second embodiment in some cases. However, it is allowable that the first image data is regarded to be equivalent to the third image data for the purpose to confirm the preparation state of the slide (for example, the thinness or thickness of the staining). The inverse transformation of the imaging in which the exposure amount is optimized in Step ST105 can be performed by multiplying a constant. The inverse transformation of the transformation performed in Steps ST106, ST107, and ST108 can be performed, for example, by calculating the inverse matrix and/or the transformation table having the inverse characteristic of the characteristic used in the foregoing steps to perform the matrix calculation. When the third image data is prepared from the second image data by means of the inverse transformation, it is necessary to obtain the information of the exposure amount used for the imaging in Step ST105 and the image processing performed in Steps ST106, ST107, and ST108. For example, the following example is referred to in relation to the information of the optimum exposure amount for the specimen subjected to the imaging in Step ST105. That is, if the twice exposure amount is used in Step ST105 when the staining is thick with respect to the fixed exposure amount in Step ST100, then the information of “twice” is stored as the information of the exposure amount. The image processing (multiplying processing to provide ½ of the luminance) is performed so that ½ of the luminance as the inverse transformation is provided, and thus the third image data is prepared.

Accordingly, in the second embodiment, the second image data is prepared in accordance with Step ST106 and the followings of the flow shown in FIG. 6. Further, information of the exposure amount used to perform the imaging in Step ST105 and the image processing performed in Steps ST106, ST107, and ST108 is added to the second image data. In the second embodiment, it is unnecessary to prepare the first image data. Therefore, the second image data may be directly generated from the imaging data outputted from the imaging device as described above. The exposure amount used to perform the imaging in Step ST105 and the transformation in Steps ST106, ST107, and ST108 are herein referred to as “condition for forming the second image data” as well.

On the other hand, the viewer, which is executed by the computer for display 2, performs the following processing in Step ST204 of the flow chart shown in FIG. 11, if the instruction command, which is inputted in Step ST202, is the command to instruct the confirmation of the preparation state of the slide. That is, the computer for display 2 performs the image processing with respect to the second image data to prepare the third image data on the basis of the information of the condition for forming the second image data added to the second image data. Further, as shown in FIGS. 1 and 2, for example, the third image data is displayed in the subsidiary display area. The following processings are the same as or equivalent to those of the first embodiment, any explanation of which will be omitted.

Usually, the observation of the image of the entire slide is not performed in the diagnosis. Therefore, the second image data, which relates to the entire slide, is not present in some cases. In such a situation, if it is necessary to provide the first image data in which the entire slide is subjected to the imaging in order to confirm the preparation state of the slide as shown in FIG. 3, the first image data is stored as it is, without acquiring the second image data in order to prepare the third image data.

In the second embodiment, the third image data is prepared from the second image data in place of the first image data, and the third image data is presented as the image to confirm the preparation state of the slide. Therefore, it is possible to reduce the size of the whole image data. It is unnecessary to store the first image data in the storage device. Therefore, it is possible to suppress the increase in the storage capacity required for the storage device.

In the digital microscope system of the second embodiment, the second image data, which is generated under the condition for forming the second image data determined adaptively for every specimen so that the observer can perform the observation with ease, is presented as the image for the diagnosis to the observer. Further, the third image data, which is provided to confirm the preparation state of the slide, is generated on the basis of the second image data and the condition for forming the second image data, in response to the request of the observer, and the third image data is presented to the observer.

As a result, when the user observes the image data obtained by the imaging by means of the imaging apparatus, the user can easily judge whether the abnormality, which is found in the image, is something caused by any abnormality existing in the specimen or any artifact resulting from the image processing. Therefore, it is possible to shorten the diagnosis time, and it is possible to reduce the erroneous diagnosis. Further, the third image data can be prepared on the basis of the second image data and the condition for forming the second image data. Therefore, the total capacity of the image data can be reduced as compared with the first embodiment.

The digital microscope system has been explained above as one example of the imaging system according to the present invention. However, the embodiment of the present invention is not limited to the digital microscope system described above.

The present invention includes, for example, a method for controlling an imaging apparatus, comprising a step of generating first image data, a step of generating second image data, and a step of generating data including the first image data and the second image data as image data of a specimen.

The present invention includes a method for controlling an imaging apparatus, comprising a step of generating third image data, a step of generating second image data, and a step of generating data including the third image data and the second image data as image data of a specimen.

The present invention includes a method for controlling a display data generating apparatus, comprising a step of acquiring image data of a specimen including first image data and second image data, and a step of generating display screen data including at least the first image data.

The present invention includes a method for controlling a display data generating apparatus, comprising a step of acquiring second image data and a condition for forming the second image data, a step of generating third image data from the second image data, and a step of generating display screen data including at least the third image data.

The present invention includes an imaging apparatus comprising a unit configured to generate first image data, a unit configured to generate second image data, and a unit configured to generate data including the first image data and the second image data as image data of a specimen.

The present invention includes an imaging apparatus comprising a unit configured to generate third image data, a unit configured to generate second image data, and a unit configured to generate data including third image data and second image data as image data of a specimen.

The present invention includes a display data generating apparatus comprising a unit configured to acquire image data of a specimen including first image data and second image data, and a unit configured to generate display screen data including at least the first image data.

The present invention includes a display data generating apparatus comprising a unit configured to acquire second image data and a condition for forming the second image data, a unit configured to generate third image data from the second image data, and a unit configured to generate display screen data including at least the third image data.

The present invention includes a computer program stored on a non-transitory computer readable storage medium for allowing an imaging apparatus to execute a step of generating first image data, a step of generating second image data, and a step of generating data including the first image data and the second image data as image data of a specimen.

The present invention includes a computer program stored on a non-transitory computer readable storage medium for allowing an imaging apparatus to execute a step of generating third image data, a step of generating second image data, and a step of generating data including the third image data and the second image data as image data of a specimen.

The present invention includes a computer program stored on a non-transitory computer readable storage medium for allowing a display data generating apparatus to execute a step of acquiring image data of a specimen including first image data and second image data, and a step of generating display screen data including at least the first image data.

The present invention includes a computer program stored on a non-transitory computer readable storage medium for allowing a display data generating apparatus to execute a step of acquiring second image data and a condition for forming the second image data, a step of generating third image data from the second image data, and a step of generating display screen data including at least the third image data.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-281835, filed on Dec. 22, 2011, and Japanese Patent Application No. 2012-170174, filed on Jul. 31, 2012, which are hereby incorporated by reference herein in their entirety.

### REFERENCE SIGNS LIST

1: image acquiring computer, 2: computer for display, 10: digital microscope.

1. A method for controlling an imaging apparatus for acquiring image data of a specimen by applying an image processing to imaging data obtained by imaging for the specimen by means of an imaging device while controlling an exposure amount determined by an exposure time and an incoming light amount per unit time allowed to come into the imaging device, the method for controlling the imaging apparatus comprising:
a step of generating first image data;
a step of generating second image data; and
a step of generating data including the first image data and the second image data as the image data of the specimen, wherein:
the first image data is generated in the step of generating the first image data by the imaging and the image processing by using the exposure amount and a parameter of the image processing to be determined while permitting provision of different values for each of distinct pieces of the first image data on condition that pixel values of pixels corresponding to portions of the specimen having an identical transmittance have an identical value in relation to all pieces of the first image data to be generated; and
the second image data is generated in the step of generating the second image data by the imaging and the image processing by using the exposure amount and a parameter of the image processing to be adaptively determined on the basis of a feature of the specimen for each of distinct pieces of the second image data to be generated.

2. A method for controlling an imaging apparatus for acquiring image data of a specimen by applying an image processing to imaging data obtained by imaging for the specimen by means of an imaging device while controlling an exposure amount determined by an exposure time and an incoming light amount per unit time allowed to come into the imaging device, the method for controlling the imaging apparatus comprising:
a step of generating second image data;
a step of generating third image data; and
a step of generating data including the second image data and the third image data as the image data of the specimen, wherein:
the second image data is generated in the step of generating the second image data by the imaging and the image processing by using the exposure amount and a parameter of the image processing to be adaptively determined on the basis of a feature of the specimen for each of distinct pieces of the second image data to be generated; and
the third image data is generated from the second image data in the step of generating the third image data by acquiring information of the exposure amount and the parameter of the image processing used to generate the second image data and performing an image processing which corresponds to inverse transformation of the imaging based on the exposure amount and an image processing which corresponds to inverse transformation of the image processing based on the use of the parameter of the image processing.

3. A method for controlling a display data generating apparatus for generating display screen data for presenting, to a user by a display apparatus, an image based on image data of a specimen acquired by an imaging apparatus for acquiring the image data of the specimen by applying an image processing to imaging data obtained by imaging for the specimen by means of an imaging device while controlling an exposure amount determined by an exposure time and an incoming light amount per unit time allowed to come into the imaging device, the method for controlling the display data generating apparatus comprising:
a step of acquiring the image data of the specimen including first image data and second image data from the imaging apparatus or a storage device; and
a step of further generating, in addition to display screen data for presenting an image based on the second image data, at least any one of display screen data for presenting an image based on the first image data and display screen data for presenting both of the image based on the first image data and the image based on the second image data, wherein:
the first image data is image data which is generated by the imaging and the image processing by using the exposure amount and a parameter of the image processing to be determined while permitting provision of different values for each of distinct pieces of the first image data on condition that pixel values of pixels corresponding to portions of the specimen having an identical transmittance have an identical value in relation to all pieces of the first image data; and
the second image data is image data which is generated by the imaging and the image processing by using the exposure amount and a parameter of the image processing to be adaptively determined on the basis of a feature of the specimen every time when the second image data is generated.

4. A method for controlling a display data generating apparatus for generating display screen data for presenting, to a user by a display apparatus, an image based on image data of a specimen acquired by an imaging apparatus for acquiring the image data of the specimen by applying an image processing to imaging data obtained by imaging for the specimen by means of an imaging device while controlling an exposure amount determined by an exposure time and an incoming light amount per unit time allowed to come into the imaging device, the method for controlling the display data generating apparatus comprising:
a step of acquiring second image data and information of the exposure amount and a parameter of the image processing used to generate the second image data from the imaging apparatus or a storage device;
a step of generating third image data from the second image data by performing, based on the use of the parameter of the image processing on the basis of the exposure amount and the parameter of the image processing, an image processing which corresponds to inverse transformation of the imaging based on the exposure amount and an image processing which corresponds to inverse transformation of the image processing with respect to the second image data; and
a step of further generating, in addition to display screen data for presenting an image based on the second image data, at least any one of display screen data for presenting an image based on the third image data and display screen data for presenting both of the image based on the third image data and the image based on the second image data.

5-6. (canceled)

7. The method for controlling the imaging apparatus according to claim 1, wherein the first image data is generated in the step of generating the first image data by the imaging and the image processing by using the common exposure amount and the common parameter of the image processing in relation to all pieces of the first image data.

8. The method for controlling the display data generating apparatus according to claim 3, wherein the first image data is image data which is generated by the imaging and the image processing by using the common exposure amount and the common parameter of the image processing in relation to all pieces of the first image data.

9. (canceled)

10. The method for controlling the imaging apparatus according to claim 1, wherein the imaging data includes a plurality of pieces of imaging data obtained by imaging the specimen a plurality of times in a divided manner while changing at least any one of an imaging position of the specimen, an imaging range of the specimen, and a magnifying magnification of the image of the specimen.

11. The method for controlling the display data generating apparatus according to claim 3, wherein the imaging data includes a plurality of pieces of imaging data obtained by imaging the specimen a plurality of times in a divided manner while changing at least any one of an imaging position of the specimen, an imaging range of the specimen, and a magnifying magnification of the image of the specimen.

12. (canceled)

13. The method for controlling the imaging apparatus according to claim 1, wherein the image processing, which is applied to the imaging data in order to generate the second image data, is an image processing which includes at least any one of a processing to improve a contrast of the imaging data, a processing to improve a dynamic range, and a processing to correct the distribution of a histogram.

14. The method for controlling the display data generating apparatus according to claim 3, wherein the image processing, which is applied to the imaging data in order to generate the second image data, is an image processing which includes at least any one of a processing to improve a contrast of the imaging data, a processing to improve a dynamic range, and a processing to correct the distribution of a histogram.

15. (canceled)

16. The method for controlling the imaging apparatus according to claim 1, wherein the image processing, which is applied to the imaging data in order to generate the first image data, is an image processing which includes at least any one of a processing to provide a common color temperature, a processing to provide a common color space, and a processing to provide a common gradation characteristic in relation to all pieces of the first image data.

17. The method for controlling the display data generating apparatus according to claim 3, wherein the image processing, which is applied to the imaging data in order to generate the first image data, is an image processing which includes at least any one of a processing to provide a common color temperature, a processing to provide a common color space, and a processing to provide a common gradation characteristic in relation to all pieces of the first image data.

18. (canceled)

19. The method for controlling the imaging apparatus according to claim 2, wherein the image processing, which is applied to the second image data in order to generate the third image data, is an image processing which includes at least any one of a processing to provide a common exposure amount, a processing to provide a common color temperature, a processing to provide a common color space, and a processing to provide a common gradation characteristic in relation to all pieces of the third image data obtained by the image processing.

20. The method for controlling the display data generating apparatus according to claim 4, wherein the image processing, which is applied to the second image data in order to generate the third image data, is an image processing which includes at least any one of a processing to provide a common exposure amount, a processing to provide a common color temperature, a processing to provide a common color space, and a processing to provide a common gradation characteristic in relation to all pieces of the third image data obtained by the image processing.

21. (canceled)

22. The method for controlling the imaging apparatus according to claim 1, wherein the first image data is image data which is generated from imaging data obtained by imaging an entire slide for supporting the specimen.

23. The method for controlling the display data generating apparatus according to claim 3, wherein the first image data is image data which is generated from imaging data obtained by imaging an entire slide for supporting the specimen.

24-27. (canceled)

28. An imaging apparatus for acquiring image data of a specimen by applying an image processing to imaging data obtained by imaging for the specimen by means of an imaging device while controlling an exposure amount determined by an exposure time and an incoming light amount per unit time allowed to come into the imaging device, the imaging apparatus comprising:
a unit configured to generate first image data;
a unit configured to generate second image data; and
a unit configured to generate data including the first image data and the second image data as the image data of the specimen, wherein:
the first image data is generated by the unit configured to generate the first image data by the imaging and the image processing by using the exposure amount and a parameter of the image processing to be determined while permitting provision of different values for each of distinct pieces of the first image data on condition that pixel values of pixels corresponding to portions of the specimen having an identical transmittance have an identical value in relation to all pieces of the first image data to be generated; and
the second image data is generated by the unit configured to generate the second image data by the imaging and the image processing by using the exposure amount and a parameter of the image processing to be adaptively determined on the basis of a feature of the specimen for each of distinct pieces of the second image data to be generated.

29. An imaging apparatus for acquiring image data of a specimen by applying an image processing to imaging data obtained by imaging for the specimen by means of an imaging device while controlling an exposure amount determined by an exposure time and an incoming light amount per unit time allowed to come into the imaging device, the imaging apparatus comprising:
a unit configured to generate second image data;
a unit configured to generate third image data; and
a unit configured to generate data including the second image data and the third image data as the image data of the specimen, wherein:
the second image data is generated by the unit configured to generate the second image data by the imaging and the image processing by using the exposure amount and a parameter of the image processing to be adaptively determined on the basis of a feature of the specimen for each of distinct pieces of the second image data to be generated; and
the third image data is generated from the second image data by the unit configured to generate the third image data by acquiring information of the exposure amount and the parameter of the image processing used to generate the second image data and performing an image processing which corresponds to inverse transformation of the imaging based on the exposure amount and an image processing which corresponds to inverse transformation of the image processing based on the use of the parameter of the image processing.

30. A display data generating apparatus for generating display screen data for presenting, to a user by a display apparatus, an image based on image data of a specimen acquired by an imaging apparatus for acquiring the image data of the specimen by applying an image processing to imaging data obtained by imaging for the specimen by means of an imaging device while controlling an exposure amount determined by an exposure time and an incoming light amount per unit time allowed to come into the imaging device, the display data generating apparatus comprising:
a unit configured to acquire the image data of the specimen including first image data and second image data from the imaging apparatus or a storage device; and
a unit configured to further generate, in addition to display screen data for presenting an image based on the second image data, at least any one of display screen data for presenting an image based on the first image data and display screen data for presenting both of the image based on the first image data and the image based on the second image data, wherein:
the first image data is image data which is generated by the imaging and the image processing by using the exposure amount and a parameter of the image processing to be determined while permitting provision of different values for each of distinct pieces of the first image data on condition that pixel values of pixels corresponding to portions of the specimen having an identical transmittance have an identical value in relation to all pieces of the first image data; and
the second image data is image data which is generated by the imaging and the image processing by using the exposure amount and a parameter of the image processing to be adaptively determined on the basis of a feature of the specimen every time when the second image data is generated.

31. A display data generating apparatus for generating display screen data for presenting, to a user by a display apparatus, an image based on image data of a specimen acquired by an imaging apparatus for acquiring the image data of the specimen by applying an image processing to imaging data obtained by imaging for the specimen by means of an imaging device while controlling an exposure amount determined by an exposure time and an incoming light amount per unit time allowed to come into the imaging device, the display data generating apparatus comprising:
a unit configured to acquire second image data and information of the exposure amount and a parameter of the image processing used to generate the second image data from the imaging apparatus or a storage device;
a unit configured to generate third image data from the second image data by performing, based on the use of the parameter of the image processing on the basis of the exposure amount and the parameter of the image processing, an image processing which corresponds to inverse transformation of the imaging based on the exposure amount and an image processing which corresponds to inverse transformation of the image processing with respect to the second image data; and
a unit configured to further generate, in addition to display screen data for presenting an image based on the second image data, at least any one of display screen data for presenting an image based on the third image data and display screen data for presenting both of the image based on the third image data and the image based on the second image data.

32-37. (canceled)
